(19) United States
(12) Patent Application Publication
(10) Pub. No.: US 2003/0091180 A1
(43) Pub. Date: May 15, 2003

(54) ADAPTIVE SIGNAL GAIN CONTROLLER, SYSTEM, AND METHOD

(76) Inventors: PATRIK SORQVIST, SPANGA (SE); ANDERS ERIKSSON, UPPSALA (SE); TOMAS SVENSSON, STOCKHOLM (SE); JIM SUNDQVIST, LULEA (SE)

Correspondence Address: ERICSSON INC., 6300 LEGACY DRIVE, M/S EVW2-C-2, PLANO, TX, 75024, US

(21) Appl. No.: 09/219,517

(22) Filed: Dec. 23, 1998

(51) Int. Cl. H04M 1/00; H04M 9/00

(52) U.S. Cl. 379/390.03; 379/387.01

(57) ABSTRACT

Adaptive gain control techniques provide correctly adjusted audio signal levels during the entirety of an Internet telephony conversation and are resilient to background noise and loudspeaker echo. Disclosed techniques can account for multiple near-end speakers, as well as changes in near-end environment. In an exemplary embodiment, an adaptive gain controller includes a gain control processor configured to adjust an analog gain for a microphone output signal based on measurements of the microphone output signal and on measurements of a loudspeaker input signal.

### FIELD OF THE INVENTION

The present invention relates to communications systems, and more particularly, to adaptive gain control in communications systems.

### BACKGROUND OF THE INVENTION

Recently, there has been a steady push to bring Internet telephony into the mainstream. An ability to transmit and receive high-quality audio signals in real time via the Internet will provide consumers with cost effective and heretofore unattainable communications solutions, particularly in the multimedia computer context. However, a present obstacle to successful implementation of such Internet telephony applications relates to audio signal gain control. Specifically, it is difficult in practice to adjust the level of an audio signal (e.g., a microphone output signal) to ensure proper and consistent operation of the speech coders and other signal processing algorithms which are commonly used to prepare the audio signal for transmission across the Internet. In other words, many such signal processing algorithms are optimized based on full use of a particular dynamic input range, and therefore require precise signal level adjustment so that incoming signals fill, but do not exceed, that range.

Conventionally, signal level adjustment is left to the application user or is made automatically based on calibration performed when the application is first installed or is first used. For example, a user is often instructed to make gain control adjustments on a multimedia computer soundboard so that a line-in or microphone signal is properly processed for transmission. Alternatively, the user can be instructed to provide a calibration signal (e.g., by speaking into a microphone or providing an audio line-in signal) upon application installation and setup, so that the soundboard gain can be automatically set.

However, since the user cannot hear the microphone or line-in signal, and since no single gain setting can account for future changes in signal level (e.g., due to changes in microphone position or differences in voice strength between users), these solutions have proven inadequate. At times, the soundboard gain is set too low, causing the speech coder and/or other processing algorithms to be less accurate. Consequently, the receiving user tends to increase the gain at the far end, resulting in a received speech signal having a poor signal-to-noise ratio and possibly including disturbing measurement noise. At other times, the soundboard gain is set too high, causing signal saturation which can prevent the speech coder and/or other processing algorithms from working as intended. Although the receiving user can decrease the far-end gain, the received speech signal may nonetheless be distorted.

Consequently, there is a need for improved methods and apparatus for adjusting signal levels in communications systems.

### SUMMARY OF THE INVENTION

The present invention fulfills the above-described and other needs by providing techniques for adaptive gain control. Advantageously, the disclosed techniques provide correctly adjusted signal levels during the entirety of a conversation and are resilient to background noise and loudspeaker echo. Further, the disclosed techniques can account for multiple near-end speakers, as well as changes in near-end environment (e.g., changes in user and microphone position).

An exemplary adaptive gain controller according to the invention includes a gain control processor configured to adjust an analog gain applied to a microphone output signal based on measurements of the microphone output signal and on measurements of a loudspeaker input signal. For example, the analog gain can be adjusted based on estimates of the average and peak speech levels in the microphone signal and on a determination of whether the microphone output signal is saturated. In exemplary embodiments, the analog gain is adjusted such that the average speech level in the microphone output signal approaches a target average level and such that the peak speech level in the microphone output signal does not exceed a maximum peak level. To improve performance, the average and peak speech level estimates are updated, in exemplary embodiments, only when voice activity detectors indicate that the microphone output signal includes speech and that the loudspeaker input signal does not include speech.

An exemplary method for adjusting the analog gain applied to a signal prior to digitization via an analog-to-digital converter includes the steps of: determining whether a digital output of the analog-to-digital converter is saturated; decreasing the analog gain if the digital output is saturated; comparing a measured average level of the communications signal to a target average level if the digital output is not saturated; decreasing the analog gain if the measured average level is too far above the target average level; comparing a measured peak level of the communications signal to a maximum peak level of the communications signal if the measured average level is too far below the target average level; and increasing the analog gain if the measured peak level is below the maximum level.

The above-described and other features and advantages of the invention are explained in detail hereinafter with reference to the illustrative examples shown in the accompanying drawings. Those of skill in the art will appreciate that the described embodiments are provided for purposes of illustration and understanding and that numerous equivalent embodiments are contemplated herein.

### BRIEF DESCRIPTION OF THE DRAWINGS

FIG. 1 is a block diagram of a communications system incorporating an exemplary adaptive gain control arrangement according to the invention.

FIG. 2 is a flow diagram depicting steps in an exemplary method of adaptive gain control according to the invention.

### DETAILED DESCRIPTION OF THE INVENTION

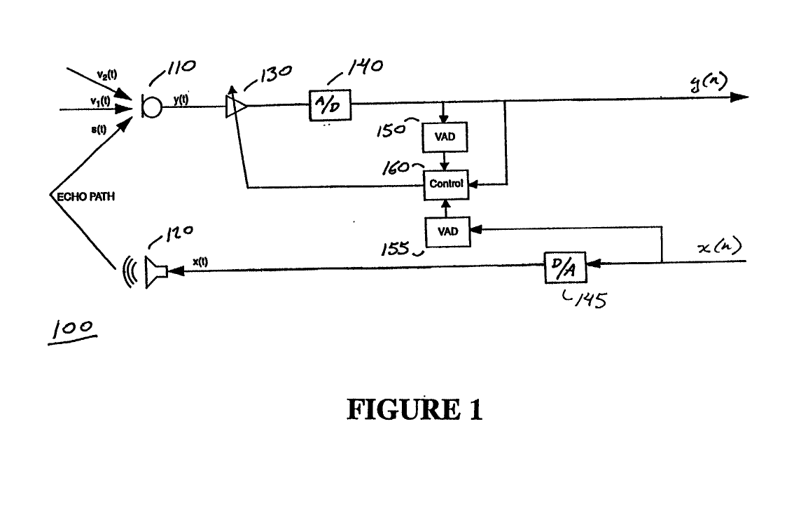

FIG. 1 depicts an exemplary Internet telephony system 100 incorporating an adaptive gain control arrangement according to the invention. Such a system can be included, for example, in a multimedia personal computer. Those of skill in the art will appreciate that the below described functionality of the various elements of the system 100 of FIG. 1 can be implemented using known analog and digital signal processing hardware and/or a general purpose digital computer.

As shown, the exemplary system 100 includes a microphone 110, a loudspeaker 120, an adjustable-gain amplifier 130, an analog-to-digital converter 140, a digital-to-analog converter 145, first and second voice activity detectors (VADs) 150, 155, and a control processor 160. A far-end digital signal x(n) (e.g., digitized far-end speech and noise received via the Internet) is input to the digital-to-analog converter 145 and to the second voice activity detector 155. The digital-to-analog converter 145 converts the far-end signal x(n) to the analog domain, and the resulting far-end analog signal x(t) is input to the loudspeaker 120 for presentation to a near-end user (not shown).

Additionally, near-end speech v₁(t), near-end noise v₂(t) and far-end echo s(t) are received at the microphone 110 and combine to produce a near-end analog signal y(t) which is amplified by the adjustable gain amplifier 130 and digitized by the analog-to-digital converter 140. The resulting digital near-end signal y(n) is input to the first voice activity detector 150 and to the control processor 160, and is also passed on to the far-end (e.g., via the Internet). Output from each voice activity detector 150, 155 is input to the control processor 160.

In operation, the control processor 160 monitors the near-end digital signal y(n), as well as the output from each voice activity detector 150, 155, and adjusts the gain of the amplifier 130 so that the level of the near-end digital signal y(n) is suitable for input to a speech coder (not shown) and/or any other digital signal processing algorithm which may be used to prepare the near-end signal y(n) for transmission. Though it is possible to make small adjustments to the digital signal level after analog-to-digital conversion and just prior to input to the speech coder or other algorithms, larger adjustments are made via the amplifier 130 to avoid undue amplification of measurement noise and to prevent distortion due to signal clipping at the analog-to-digital converter 140.

Generally, the control processor 160 measures the average level of near-end speech in the near-end signal y(n) and adjusts the gain of the amplifier 130 so as to continually push the measured average level toward a target, or preferred average level (e.g., −22dBoV, as defined in the Subscriber Loop Signaling and Transmission Handbook, Whitman D. Reeve, IEEE Press, 1992, pp. 95-97). In order to make the gain control system more robust, gain adjustments can be conditioned, as is described in detail below, on the outputs of the voice activity detectors 150, 155 and on a test for signal saturation. Further, as is also described in detail below, gain adjustments can also be conditioned on a measurement of the peak level of the near-end speech in order to prevent gain adjustment errors when two or more near-end users are speaking.

According to an exemplary embodiment, a running estimate of the average level of near-end speech in the near-end signal y(n) is updated at the end of each of a succession of near-end signal sample blocks (e.g., at the end of each 160-sample GSM speech frame). However, to avoid erroneous gain adjustments based on periods when the near-end user is not speaking, the estimate of the average near-end speech level is updated only when the first voice activity detector 150 indicates that the near-end signal y(n) includes speech. Further, since far-end echo can cause the first voice activity detector 150 to indicate speech even though the near-end user is not speaking, the estimate is updated only when the second voice activity detector 155 indicates that the far-end signal x(n) does not include speech. Techniques for constructing the voice activity detectors 150, 155 are well known and are described, for example, in ETSI, GSM 06:32, European Digital Cellular Telecommunication System Voice Activity Detection, Version 4.3.1, April 1998.

During periods of near-end single-talk (as indicated by the voice activity detectors 150, 155), the running estimate of the average near-end speech level is updated at the end of each block of samples (e.g., at the end of each GSM frame) by first computing an average level r_{y} of the overall near-end signal y(n) for the block of samples. In other words, for a block of N (e.g., 160) samples, the average near-end signal level r_{y} is computed as:

$${r}_{y} = \frac{1}{N} {\sum }_{n = 0}^{N - 1} {y ( n )}^{2} .$$

Then, the near-end speech level for the frame is computed by subtracting an estimate of the near-end noise level (which can be computed during periods of no near-end speech and no far-end speech, as indicated by the voice activity detectors 150, 155) from the computed near-end signal level. In other words, the near-end speech level rᵥ₁ is computed as the difference between the near-end signal level r_{y} and the noise level rᵥ₂:

rᵥ₁=r_{y}−rᵥ₂.

Once the near-end speech level for the frame is known, the running estimate of the average near-end speech level rₐᵥ is updated by smoothing from frame to frame. In other words, the average level estimate rₐᵥ is updated as:

r_{αv}=αr_{αv}+(1−α)rᵥ₁

where α is an update coefficient (a real number) set to provide a balance between speed of gain adaptation and system stability. Empirical studies have shown that 0.995 is a suitable value for the update coefficient α.

By monitoring the average near-end speech level in this block-wise fashion, periodic amplifier gain adjustments can be made to keep the average near-end speech level at or near the target level (e.g., within a range of values around the target level). For example, the gain can be incrementally adjusted every several blocks (e.g., every 30 to 50 GSM frames) based on a comparison of the running average estimate rₐᵥ and the target value (e.g., −22dBoV). In other words, if the running estimate rₐᵥ is too far above or below the target level at the end of several blocks, then the amplifier gain can be stepped down or up by an appropriate amount (e.g., 1-3dB). By adjusting the gain only once every several blocks or frames, and by gradually stepping the gain toward the target value, bothersome gain fluctuations are avoided. Advantageously, the interval (e.g., the number of blocks or frames) between gain adjustments can be changed over time. For example, adjustments can be made more frequently during an early training period and less frequently thereafter.

While the above described technique provides quality gain control when only one near-end user is present, it can yield unsatisfactory results when multiple near-end users are speaking. In other words, when two or more users having different voice levels are speaking, the above described average level estimate will incorporate all of the voice levels and can thus lead to over-amplification and clipping when the loudest user(s) are speaking.

However, another exemplary embodiment solves this problem by considering the peak level of the near-end speech. Specifically, a running estimate of the peak near-end speech level is computed in block-wise fashion as:

rₚₑₐₖ=Max(βrₚₑₐₖ+(1−β)rᵥ₁, rᵥ₁)

where β is a real update coefficient (e.g., 0.995), and where the speech level for a frame rᵥ₁ is computed as described above. Like the average level estimate rₐᵥ, the peak level estimate rₚₑₐₖ is updated only when the voice activity detectors 150, 155 indicate a near-end single talk condition. By ensuring that the peak level estimate does not exceed a target value (e.g., −16dBoV), over-amplification can be avoided when multiple near-end users are present. For example, the control processor 160 can be configured to permit gain increases (as indicated by the average level estimate) only when the peak level estimate is below the target peak level.

Advantageously, the above described gain control techniques can be made still more robust by considering saturation of the analog-to-digital converter 140. For example, if gain increases (as indicated, for example, by the above described average and peak level estimates) are permitted only when the converter 140 is not saturated (as indicated, for example, when the output signal y(n) has a value equal to the minimum or maximum of the converter output range), or if the gain is decreased whenever saturation is detected, then signal clipping and the resulting distortion can be minimized.

According to an exemplary embodiment, saturation is monitored by maintaining a running saturation counter. At the end of each block or frame, the number of saturated samples L in the block or frame is determined (e.g., samples having the minimum or maximum converter output value are counted). If the number of saturated samples L in the block or frame is greater than or equal to a per-block saturation threshold T1 (e.g., 2), then the saturation counter is incremented by the number of saturated samples L. However, if the number of saturated samples L in the block or frame is less than the per-block threshold T1, then the saturation counter is decreased by a predetermined amount M (e.g., an integer in the range 1-5). Whenever the saturation counter becomes greater than or equal to an overall saturation threshold T2 (e.g., 50), the amplifier gain is stepped down, and the saturation counter is reset. However, as long as the saturation counter is less than the overall saturation threshold T2, the amplifier gain is adjusted in some suitable fashion (e.g., based on the above described average and peak level estimates). Note also that consecutive saturated samples can be assigned a larger weight (e.g., 2) as compared to single saturated samples (since a single saturation sample may be inaudible, while consecutive saturated samples are often disturbing to a receiving user). Empirical studies have shown the above described technique to be an effective and stable way of preventing saturation while maintaining appropriate gain control.

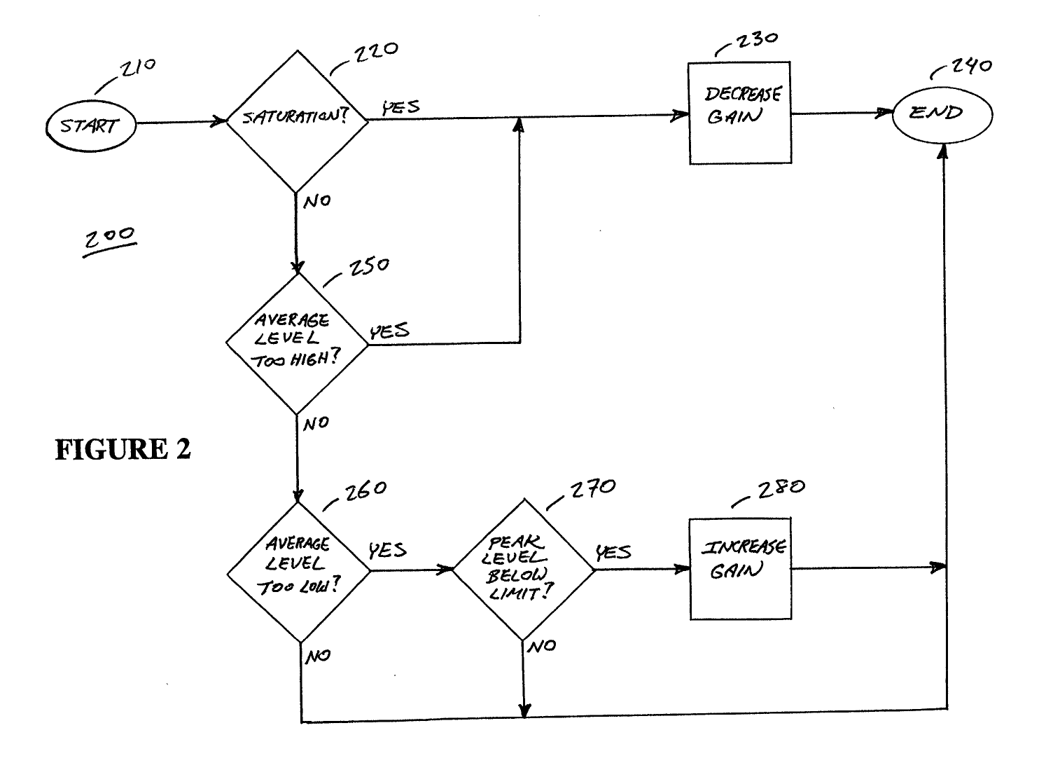

Generally, effective gain control can be accomplished, according to the invention, by making gain adjustment decisions based on any combination of the above described average, peak and saturation parameters. An exemplary decision algorithm 200 is depicted in FIG. 2. The exemplary algorithm can be used, for example, to make amplifier gain adjustments once every several (e.g., 30-50) frames (where it is understood that the above described average level estimate, peak level estimate and saturation counter are updated at the end of each frame).

The decision algorithm begins at step 210, and at step 220 a determination is made whether the amplified and digitized signal y(n) is saturated (e.g., whether the running saturation counter is greater than the saturation threshold T2). If so, then the amplifier gain is decreased (e.g., by 1-3dB) at step 230, and the decision algorithm is complete at step 240. If not, then a determination is made (at step 250) whether the signal level is too high (e.g., whether the average speech level estimate is too far above the target average level). If so, then the amplifier gain is decreased at step 230, and the decision algorithm is complete at step 240. If not, then a determination is made (at step 260) whether the signal level is too low (e.g., whether the average speech level estimate is too far below the target average level). If not, then the amplifier gain is not modified, and the decision algorithm is complete at step 240. If so, then a determination is made (at step 270) whether the peak signal level is within an appropriate range (e.g., whether the peak speech level estimate is less than the target peak value). If not, then the amplifier gain is not modified, and the decision algorithm is complete at step 240. If so, then the amplifier gain is increased (e.g., by 1-3dB) at step 280, and the decision algorithm is complete at step 240.

As note above, the disclosed gain control techniques provide correctly adjusted signal levels during the entirety of a conversation and are resilient to background noise and loudspeaker echo. Further, the disclosed techniques can account for multiple near-end speakers, as well as changes in the near-end environment (e.g., changes in user and microphone position).

Advantageously, the disclosed techniques can be made to work in conjunction with other adaptive signal processing algorithms, such as noise suppression algorithms and/or adaptive-filter echo canceling algorithms. For example, as is well known in the art, echo cancelers use an adaptive algorithm (e.g., Least Mean Squares, or Normalized Least Mean Squares) to develop an estimate of the echo s(t) which is subtracted from the near-end signal y(n) to provide an echo-canceled signal. According to the present invention, gain changes made using the above described techniques can be reported directly to such an echo canceler so that the adaptive filter coefficients of the echo canceler can be adjusted immediately. As a result, the echo canceler will not require additional time to adapt to level changes introduced by the above described techniques. When a storage buffer is positioned between the analog-to-digital converter 140 and the gain control processor 160 (e.g., so that the gain control processor 160 operates on stored samples), the resulting signal delay (i.e., the time required for analog gain changes at the amplifier 130 to be reflected in the output signal y(n)) is taken into account when reporting gain changes to the echo canceler (or other adaptive algorithm).

Those skilled in the art will appreciate that the present invention is not limited to the specific exemplary embodiments which have been described herein for purposes of illustration and that numerous alternative embodiments are also contemplated. For example, although the embodiments have been described with respect to real-time Internet telephony, the disclosed concepts are equally applicable in any communications context where adaptive gain control of a signal is necessary or desirable (e.g., voice mail and other digital telephony applications). The scope of the invention is therefore defined by the claims appended hereto, rather than the foregoing description, and all equivalents which are consistent with the meaning of the claims are intended to be embraced therein.

1. An adaptive gain controller for use in a communications device including a microphone and a loudspeaker, comprising:
a gain control processor configured to adjust an analog gain applied to a microphone output signal of said device based on the microphone output signal and on a loudspeaker input signal of said device.

2. The adaptive gain controller of claim 1, wherein said gain control processor adjusts the analog gain based on an estimate of an average speech level in the microphone output signal.

3. The adaptive gain controller of claim 2, wherein said gain control processor adjusts the analog gain such that the average speech level in the microphone output signal approaches a target average level.

4. The adaptive gain controller of claim 2, further comprising a first voice activity detector configured to indicate whether the microphone output signal includes speech.

5. The adaptive gain controller of claim 4, wherein the average speech level estimate is updated only when said first voice activity detector indicates that the microphone output signal includes speech.

6. The adaptive gain controller of claim 4, further comprising a second voice activity detector configured to indicate whether the loudspeaker input signal includes speech.

7. The adaptive gain controller of claim 6, wherein the average speech level estimate is updated only when said first voice activity detector indicates that the microphone output signal includes speech and said second voice activity detector indicates that the loudspeaker input signal does not include speech.

8. The adaptive gain controller of claim 1, wherein said gain control processor adjusts the analog gain based on an estimate of a peak speech level in the microphone output signal.

9. The adaptive gain controller of claim 8, wherein said gain control processor adjusts the analog gain such that the peak speech level in the microphone output signal does not exceed a maximum peak level.

10. The adaptive gain controller of claim 1, wherein said gain control processor adjusts the analog gain based on a determination of whether the microphone output signal is saturated.

11. The adaptive gain controller of claim 10, wherein said gain control processor decreases the analog gain when the microphone output signal is saturated.

12. The adaptive gain controller of claim 2, wherein the estimate of the average speech level is adjusted to compensate for noise in the microphone output signal.

13. The adaptive gain controller of claim 2, wherein said gain control processor is configured to report gain adjustments to another adaptive processor of said communications device.

14. The adaptive gain controller of claim 13, wherein said another adaptive processor is an adaptive echo canceler.

15. The adaptive gain controller of claim 13, wherein said another adaptive processor is an adaptive noise suppressor.

16. The adaptive gain controller of claim 13, wherein digital samples of the microphone output signal are stored in a buffer, wherein said gain control processor operates on stored samples of the microphone output signal, and wherein said gain control processor compensates for delays in effecting analog gain adjustments when reporting the gain adjustments to said another adaptive processor.

17. The adaptive gain controller of claim 1, wherein said gain control processor adjusts the analog gain based on at least one of an estimate of an average speech level in the microphone signal, an estimate of a peak speech level in the microphone signal and a determination of whether the microphone output signal is saturated.

18. A method for adjusting an analog gain applied to a communications signal prior to digitization of the communications signal via an analog-to-digital converter, comprising the steps of:
determining whether a digital output of the analog-to-digital converter is saturated;
decreasing the analog gain if the digital output is saturated;
comparing a measured average level of the communications signal to a target average level if the digital output is not saturated;
decreasing the analog gain if the measured average level is too far above the target average level;
comparing a measured peak level of the communications signal to a maximum peak level of the communications signal if the measured average level is too far below the target average level; and
increasing the analog gain only if the measured peak level is below the maximum peak level.
